(19) United States
(12) Patent Application Publication
(10) Pub. No.: US 2016/0350799 A1
(43) Pub. Date: Dec. 1, 2016

(54) Systems and Methods for Incentivizing Social Commerce

(71) Applicant: Abiodun Johnson, Far Rockaway, NY (US)

(72) Inventor: Abiodun Johnson, Far Rockaway, NY (US)

(73) Assignee: CoSign Inc., New York, NY (US)

(21) Appl. No.: 14/723,097

(22) Filed: May 27, 2015

(51) Int. Cl. G06Q 30/02; G06K 9/00; G06F 17/30; G06Q 50/00

(52) U.S. Cl. CPC G06Q 30/0246; G06Q 30/0277; G06Q 30/0273; G06Q 50/01; G06K 9/00973; G06F 17/30312; G06F 17/3028

(57) ABSTRACT

Systems and methods for incentivizing social commerce are disclosed. The disclosed systems and methods enable tagging of products and services in user-generated content. The tags are persistent and contain purchasing metadata such that users with whom the user-generated content is shared may purchase the tagged products or services. The disclosed systems and methods further enable compensating users for tagging and sharing user-generated content by monitoring viewing and purchasing activity associated with the user-generated content.

### CROSS-REFERENCE TO RELATED APPLICATION

This application claims the benefit of Applicant's prior provisional application No. 62/003,429, filed on May 27, 2014.

### FIELD OF INVENTION

The present technology generally relates to the field of interactive advertising and content delivery, and has certain specific applications to distribution and compensation schemes in online advertising.

### BACKGROUND

Electronic commerce, or e-commerce, constitutes a growing percentage of retail business. Mobile commerce, spurred on by the rapid proliferation of internet-enabled mobile computing devices, including smartphones, tablet computers, and wearable devices, has emerged as a particularly high-growth sector of e-commerce.

At the same time, social media applications have become some of the most popular aspects of daily interne usage, with Facebook alone boasting nearly one billion active daily users. More and more, users are accessing social media sites and content via mobile devices.

These developments have led to rapid growth in social media advertising, which relies on social networks to generate, target, and deliver advertising content to consumers. Through social media, businesses can connect with consumers around the globe and can target advertising to consumers based on data on their social media interests, behaviors, and usage patterns.

Increasingly, “social proof” plays a growing role in driving consumer behavior in social media advertising and e-commerce. Social proof refers to the assumption that the actions of others reflect the correct behavior for a given situation. For example, referrals to products or services that originate with a user's friends result in higher sales conversion rates and higher average spending. In the social media context, consumers are more likely to purchase items recommended, reviewed, or shared by others in their networks via user-generated content.

Yet, while businesses and advertisers are developing increasingly sophisticated forms and uses of social proof, the “purchase path” from the discovery and recommendation of a product or service to end sale remains complex. The need to complete multiple intermediate steps, and the variety of countervailing influences encountered along the way, results in lower conversion rates, and thus lower sales revenues, for advertisers and businesses.

Furthermore, most social media users are provided few incentives to share or promote products or services of interest to others. This contributes to sub-optimal sales conversion rates. While professional bloggers and users with substantial social media networks can monetize endorsements via referral agreements, such compensation arrangements are rarely available to regular users.

What is needed is technology that allows users to immediately purchase a product or service that they see in advertisements and user-generated content, and incentivizes users to share and proliferate advertisements through their social networks and web properties. The combination of immediate purchasing, built-in social proof, and incentivized proliferation expands advertising reach and can increases sales of advertised products and services.

### SUMMARY

In one aspect, the disclosed technology provides downloadable and non-downloadable software applications to enable immediate purchasing of products and services displayed in advertising. The applications allow users to capture a digital media file, for example by uploading the file or by taking a photograph via a camera-enabled mobile device. The applications then generate an interactive media file as user-generated content and store the user-generated content on a server computer. The interactive media file is a digital container format that includes a high-quality replica of the uploaded file, together with metadata used to enable the features described herein.

In another aspect, a product database configured to store such information is pre-populated with information about products and services available for purchase and may include, for each product or service, a representative image and purchasing metadata, such as cost, vendor identity, inventory and availability, and a direct link to a web page where the product or service can be purchased immediately on the user's computer or mobile device.

In another aspect, a user interface enables content editing and content tagging features. For example, users may crop or caption stored images. Users may also tag multiple objects pictured in stored user-generated content with metadata tags visualized as interactive icons and linked to purchasing metadata stored in the above-referenced product database.

In another aspect, the user interface enables e-commerce features. For example, a purchase button is provided for each tagged object in user-generated content. Pressing the purchase button activates a direct link to a web page where the corresponding product or service can be purchased immediately on the user's computer or mobile device.

In another aspect, an interaction database is configured to store individual and aggregate user behavior captured by monitoring usage and interaction behavior, including the number of views, purchases, clicks, and social media interactions associated with each piece of user-generated content as well as with each user.

In another aspect, the user interface enables content sharing features. For example, after tagging objects in user-generated content, users may share the content with others via email, by uploading to blogs or other web properties, or by posting the user-generated content to various social networking sites. The tags, which contain purchasing metadata, are persistent and follow the user-generated content, so that any third party who views the user-generated content can interact with the tags and purchase the tagged products or services.

In another aspect, the disclosed technology provides downloadable and non-downloadable software applications to enable rewarding users who tag products and services in advertising and share tagged advertisements, via monetary and non-monetary rewards.

### BRIEF DESCRIPTION OF THE DRAWINGS

Various embodiments of the present technology are disclosed in the following detailed description and accompanying drawings.

FIG. 1 illustrates a system in accordance with the disclosed technology.

FIG. 2 illustrates a flowchart representative of one embodiment of a method for rewarding a user of an application in accordance with the disclosed technology.

FIG. 3 illustrates a flowchart representative of one embodiment of a method for enabling persistent tagging of products and services in digital advertisements in accordance with the disclosed technology.

### DETAILED DESCRIPTION AND PREFERRED EMBODIMENTS

The following is a detailed description of exemplary embodiments to illustrate the principles of the invention. The embodiments are provided to illustrate aspects of the invention, but the invention is not limited to any one embodiment. The scope of the invention encompasses numerous alternatives, modifications, and equivalents; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

Before the disclosed technology is illustrated in greater detail, some terms used in this disclosure are defined for the purpose of clarification.

Definitions.

A. As used herein, “application” shall mean web-based or mobile application software executing on a computer or mobile device.

B. As used herein, to “CoSign” shall mean to tag a digital media file with metadata that permits users to purchase one or more products or services portrayed in or associated with the file, and/or to share the tagged file with others, such as by uploading it to a server computer or posting it to a social networking site.

C. As used herein, “mobile device” or “mobile computing device” shall mean a portable (handheld or wearable) computing device with wireless communication capabilities, such as cellular telephony and data connectivity. Typical mobile devices include, without limitation, smartphones, tablet computers, and wearable computing devices.

D. As used herein, “subscription agreement” shall mean a legal agreement between an advertiser or purveyor of products or services for sale and an administrator of the disclosed technology.

E. As used herein, “tag” shall mean metadata assigned to an item of information within a particular file. In general, a tag helps describe the item to which it is assigned and allows the item to be found again via browsing or searching. For example, a tag may include, but not be limited to, product name, store availability, user rating, and product pricing information. “To tag” an item of information shall mean to assign a tag to that item of information.

F. As used herein, “user” shall mean any person making use of or practicing one or more of the various embodiments of the disclosed technology.

G. As used herein, “user-generated content” shall mean information or content of any type or medium, including but not limited to images, video or audio files, and other forms of communication transmitted through, uploaded to, and/or hosted on the hosting server at the request of, or through the action of, a user. User-generated content may be abbreviated as “UGC.”

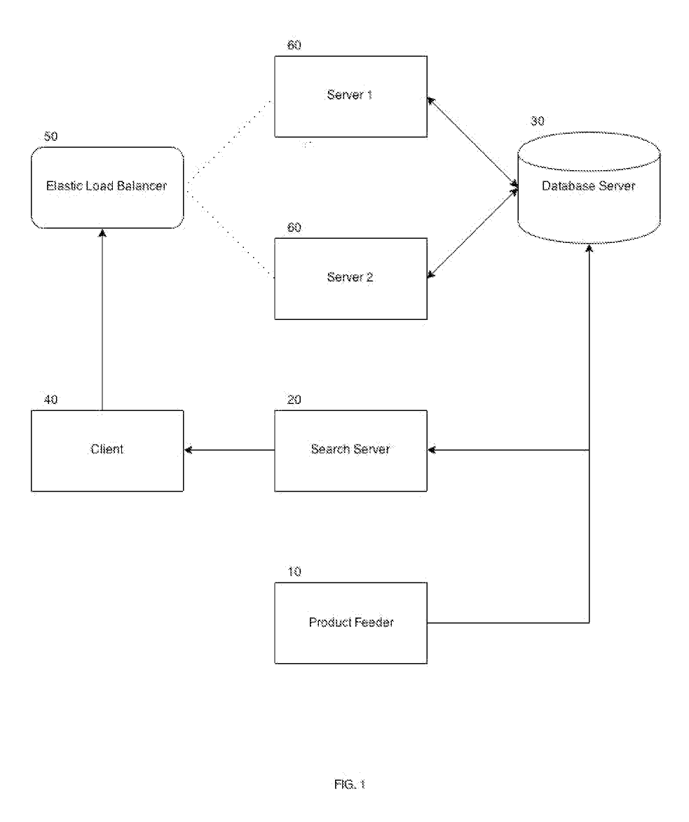

An illustrative, non-limiting embodiment of the disclosed technology will be described in connection with FIG. 1. A product feeder application (10) deploys on a cloud-based server.

The product feeder (10) regularly updates new product feeds based on information from affiliate search engines. The search engines execute on a Solr enterprise search server (20). The search server includes a database that synchronizes with a product database running on a database server (30).

The database server (30) stores cloud-based, distributed, relational databases for use in applications. The database server (30) can contain, for example, a product database containing information about a plurality of products and services, and an interaction database configured to store individual and aggregate user behavior captured by monitoring usage and interaction behavior, including the number of views, purchases, clicks, and social media interactions associated with each piece of user-generated content as well as with each user. Task queues running on the product feeder (10) regularly update the relevant database(s) on the database server (30).

A plurality of server-based applications execute on a client server (40). These applications may provide varied functionality in accordance with the disclosed technology. For example, they can provide content interaction features for user-directed tagging, sharing, and retrieval of user-generated content, and e-commerce features for linking to and purchasing items tagged in user-generated content. They can also provide features for monitoring interaction by a plurality of users with user-generated content associated with a specific user, determining and assigning a reward for each type and instance of interaction of users with content posted by the specific user, and providing the specific user with the determined reward.

An elastic load balancer (50) automatically distributes incoming traffic from applications running on the client (40) across a plurality of cloud-based servers (60) based on incoming traffic load.

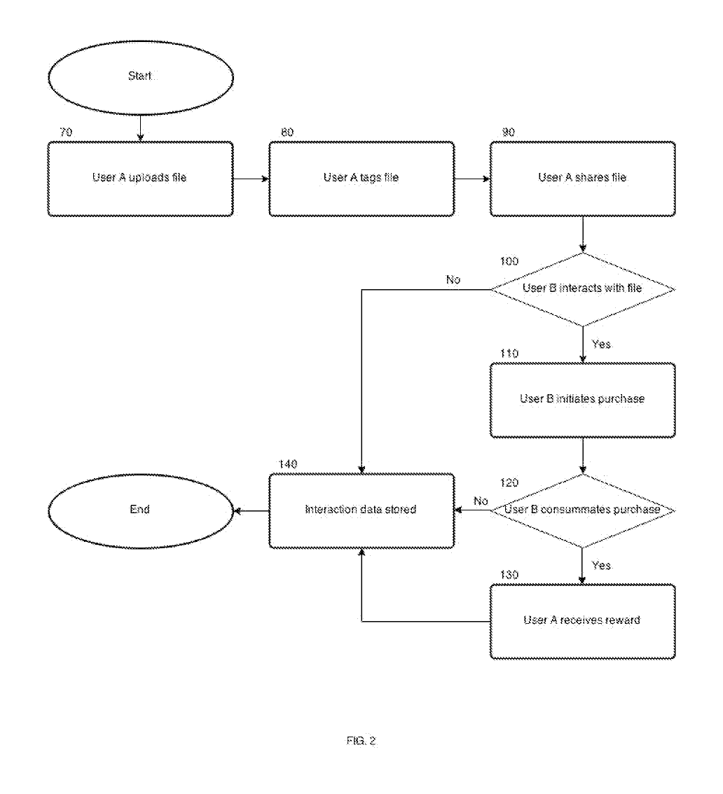

A further illustrative, non-limiting embodiment of the disclosed technology will be described in connection with FIG. 2. A user A uploads a digital media file (70) depicting a product or service that is offered for sale. The digital media file can be, for example, an original image captured by the user A (e.g., user A photographs a new watch that the user has purchased, and uploads the photograph to a data server) or a photographic or video replica of an existing advertisement (e.g., user A photographs a watch advertisement appearing in a magazine, and uploads the photograph to a data server). In preferred embodiments, the product or service for sale is pre-indexed in the system pursuant to a subscription agreement.

After uploading the digital media file, the user A tags one or more products and/or services for sale in the digital media file using smart tags (80). An interactive media file containing tag metadata is generated and stored on a server computer.

The user A then shares the interactive media file (90). The mode of sharing can be by various known means of disseminating an image to third parties such as by posting the image to social networking sites (including Facebook, Instagram, Twitter, Pinterest, Tumblr, and Google+), via a dedicated website or blog, or by any other means in which digital content can be shared with others.

Any subsequent user B who views the interactive media file (100) can view the associated persistent tag metadata. By interacting with the tags, the subsequent user B can initiate a purchase of the tagged product or service. The disclosed system monitors and records the subsequent user B's interaction with the interactive media file (130), including whether the subsequent user B views the associated tags and initiates a purchase via a provided purchase button (110).

If the subsequent user B does not initiate a purchase transaction, the system's involvement with the subsequent user B is terminated (110). Data representing the subsequent user B's interaction with the interactive media file is recorded and transmitted to an interaction database for storage (140).

If the subsequent user initiates a purchase transaction, the system monitors whether the subsequent user B actually consummates the purchase transaction. If the subsequent user B consummates the transaction (120), then the first user A receives a reward, which may be a monetary reward (e.g., a commission equal to a percentage of the sale of the product or service) or a non-monetary reward (e.g., reward points that may be used and redeemed as credits within the system) (130). Data representing the subsequent user B's interaction with the interactive media file is recorded and transmitted to an interaction database for storage (140).

While in the above example, the first user A only receives a reward if a subsequent user B actually purchases a product or service tagged in or associated with the first user A's user-generated content, other variations are possible and remain within the scope of the presently disclosed technology. The first user A can also be compensated, e.g., based on the number of times a subsequent user B visits an uploaded piece of user-generated content, when a subsequent user “likes” or “favorites” the product within a social networking platform that provides such features, or when a subsequent user B initiates but does not consummate a purchase transaction.

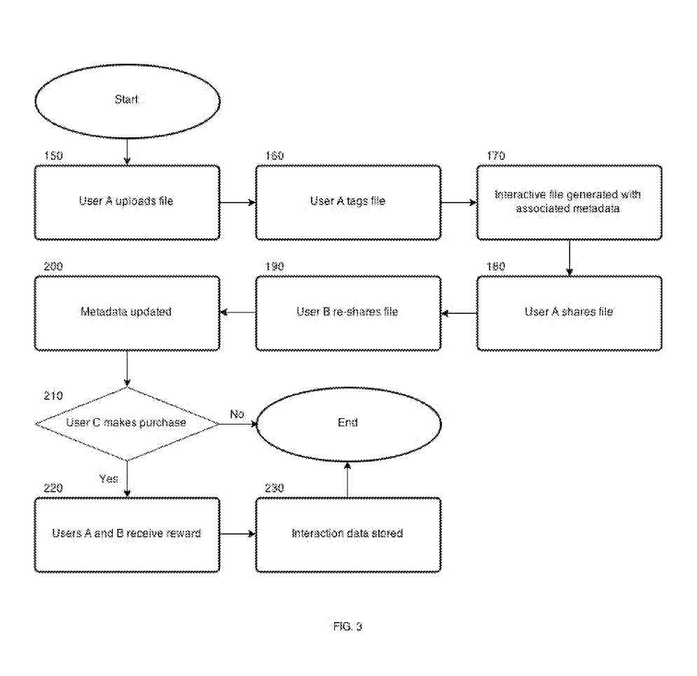

A further illustrative, non-limiting embodiment of the disclosed technology will be described in connection with FIG. 3. A user A uploads a digital media file (150) depicting a product or service that is offered for sale. The digital media file can be, for example, an original image captured by the user A (e.g., user A photographs a new watch that the user has purchased, and uploads the photograph to a data server) or a photographic or video replica of an existing advertisement (e.g., user A photographs a watch advertisement appearing in a magazine, and uploads the photograph to a data server). In preferred embodiments, the product or service for sale is pre-indexed in the system pursuant to a subscription agreement.

After uploading the digital media file, the user A tags one or more products and/or services for sale in the digital media file using smart tags (160). An interactive media file containing tag metadata is generated and stored on a server computer (170).

The user A then shares the interactive media file (180). The mode of sharing can be by various known means of disseminating an image to third parties such as by posting the image to social networking sites like Facebook and Instagram, via a dedicated website or blog, or by any other means in which digital content can be shared with others.

Any subsequent user B who views the interactive media file can view the associated persistent tag metadata and can re-share the file by similar means, thereby “CoSigning” the file (190). The metadata associated with the interactive media file is updated to reflect user B's association with the file via the CoSigning process (200).

A third user C may now view the file that has been shared by user A or CoSigned and re-shared by user B. If the third user C initiates a purchase transaction for a product or service depicted in the file, the system monitors whether the third user C actually consummates the purchase transaction (210). If the third user C consummates the transaction, then each of users A and B receives a reward, which may be a monetary reward (e.g., a commission equal to a percentage of the sale of the product or service) or a nor -monetary reward (e.g., reward points that may be used and redeemed as credits within the system) (220). Data representing the users A and B's interactions with the interactive media file is recorded and transmitted to an interaction database for storage (230).

As noted above, a subscription agreement can be implemented between the advertiser or purveyor of a product or service offered for sale and an administrator of the present system. In certain embodiments, the products and services offered for sale are limited to those associated with the subscription agreement. In certain other embodiments, particularly those in which products or services are associated with a subscription agreement, metadata from the product database is automatically populated and displayed using visual recognition technology when a user uploads user-generated content displaying products or services associated with a subscription agreement.

The disclosed embodiments are illustrative, not restrictive. While specific configurations of the invention have been described, it is understood that the present invention can be applied to a wide variety of e-commerce and social media advertising applications. There are many alternative ways of implementing the invention.

What is claimed is:

1. A computer network system for enabling incentive-based social advertising and purchasing of products and services, comprising:
a server having a processor and at least one storage device connected to the processor;
a server-based application accessible by a plurality of users using a client-server application interface, wherein the application interface provides content interaction features for user-directed tagging, sharing, and retrieval of user-generated content, and e-commerce features for linking to and purchasing items tagged in user-generated content;
a product database containing information for a plurality of products and services; and
a stored software application operative with the processor to monitor interaction by the plurality of users with user-generated content associated with a specific user, determine and assign a reward for each type and instance of interaction of users with content posted by the specific user, and provide the specific user with the determined reward.

2. The system of claim 1, further comprising a database of user-generated content posted by the plurality of users.

3. The system of claim 1, wherein the stored software application associates user-generated content with a specific user based on the specific user's interactions with the user-generated content.

4. The system of claim 1, wherein the stored software application generates persistent metadata tags that associate product purchasing information with the user-generated content.

5. The system of claim 1, further comprising an image recognition database stored on the server and comprised of images of all products and services in the product database.

6. The system of claim 5, further comprising image recognition software executing on the server and configured to automatically detect and distinguish products and services appearing in user-generated content by accessing the image recognition database and comparing images in the user-generated content to images stored in the image recognition database.

7. The system of claim 6, wherein for every piece of user-generated content shared, posted, or uploaded by a user, the stored software application generates a digital container format comprising a high-quality replica of the user-generated content together with persistent metadata tags that associate product purchasing information with the user-generated content by inputting the user-generated content into the image recognition software.

8. A method for enabling persistent tagging of products and services in digital advertisements, comprising:
providing an application accessible by a plurality of users, wherein the application interface provides content interaction features for user-directed tagging, sharing, and retrieval of user-generated content;
providing a product database containing information for a plurality of products and services;
storing a digital media file on a server;
receiving a request from a user to associate a product or service from the product database with the digital media file;
generating a tag for the digital media file based on the request, wherein the tag identifies an association of the product or service with the digital media file, and the tag further includes metadata to facilitate the purchase of the product or service via an online vendor;
persistently associating the tag with the digital media file such that the tag remains associated with the digital media file after the digital media file is distributed from the server.

9. The method of claim 8, wherein the tag further identifies an association of the digital media file with the user that initiated the association request.

10. The method of claim 8, further comprising enabling a third party to view information contained in the tag by interacting with the digital media file.

11. The method of claim 8, further comprising enabling a third party to purchase the associated product or service by interacting with the digital media file.

12. The method of claim 11, wherein the purchase is initiated and completed within the application interface.

13. The method of claim 11, wherein the purchase is initiated by directing the third party to an external e-commerce website.

14. The method of claim 8, further comprising enabling the sharing and distribution of the digital media file with associated tags on social networking sites.

15. A method for rewarding a user of an application, comprising:
providing an application accessible by a plurality of users, wherein the application interface provides content interaction features for user-directed tagging, sharing, and retrieval of user-generated content, and e-commerce features for linking to and purchasing items tagged in user-generated content;
monitoring interaction by the plurality of users with content tagged and posted by a specific user;
determining and assigning a reward for each type and instance of interaction of users with content posted by the specific user;
aggregating and monitoring the specific user's determined rewards; and
providing the specific user with the determined rewards.

16. The method of claim 15, wherein advertising information is associated with the specific user's content, monitoring comprises determining the total amount of advertising revenue generated by third-party viewing of the content-associated advertisement, and the reward provided to the specific user is a portion of advertising revenue.

17. The method of claim 15, wherein product pricing and availability information is associated with the specific user's content, monitoring comprises determining the total amount of sales revenue generated by third-party purchasing of items tagged in the specific user's content, and the reward provided to the specific user is a portion of sales revenue.

18. The method of claim 15, wherein determining and assigning a reward to the specific user comprises at least one of determining the number of unique views received by the specific user's content, determining the number of times the specific user's content is retrieved from a database, determining the total amount of advertising revenue generated based on third-party viewing of user-specific content-associated advertisements, and determining the total amount of sales revenue generated by third-party purchasing of items tagged in the specific user's content.

19. The method of claim 15, wherein the reward provided to the specific user is a monetary reward equal to a portion of revenue generated by content posted by the specific user.
